(19) United States
(12) Patent Application Publication
(10) Pub. No.: US 2021/0311368 A1
(43) Pub. Date: Oct. 7, 2021

(54) OPTICAL SCANNING APPARATUS, IMAGE PICKUP APPARATUS, ADJUSTMENT APPARATUS FOR OPTICAL SCANNING APPARATUS, AND METHOD FOR ADJUSTING OPTICAL SCANNING APPARATUS

(71) Applicant: OLYMPUS CORPORATION, Tokyo (JP)

(72) Inventor: Yoshihito IGUCHI, Tokyo (JP)

(73) Assignee: OLYMPUS CORPORATION, Tokyo (JP)

(21) Appl. No.: 17/211,143

(22) Filed: Mar. 24, 2021

Related U.S. Application Data
(63) Continuation of application No. PCT/JP2018/036002, filed on Sep. 27, 2018.

(51) Int. Cl. G02F 1/29

(52) U.S. Cl. CPC G02F 1/29; G02F 2203/18

(57) ABSTRACT

An optical scanning apparatus includes a light source; an optical fiber; a wavefront modulator configured to emit light, a reference wavefront of which is corrected, based on information about the reference wavefront and correction information and make the light incident upon the first end face via a predetermined optical system; and a processor configured to control the wavefront modulator based on the correction information and the information about the reference wavefront, the correction information being found based on a correlation between a first distribution and a second distribution, the first distribution being at least one of an intensity distribution or a phase distribution of emergent light from the second end face, the second distribution being at least one of an intensity distribution or a phase distribution of the desired light.

### CROSS REFERENCE TO RELATED APPLICATION

This application is a continuation application of PCT/JP2018/036002 filed on Sep. 27, 2018, the entire contents of which are incorporated herein by this reference.

### BACKGROUND OF THE INVENTION

### 1. Field of the Invention

The present invention relates to an optical scanning apparatus using an optical fiber, an image pickup apparatus, an adjustment apparatus for the optical scanning apparatus, and a method for adjusting the optical scanning apparatus.

### 2. Description of the Related Art

An optical fiber includes a part with a high index of refraction, called a core, and a part with a low index of refraction, placed around the core and called a cladding. Light incident upon the optical fiber having such a structure propagates through a boundary between the core and the cladding via total reflection and the like. Of optical fibers of this type, optical fibers having multiple propagation modes (light paths) are called multimode fibers.

For example, U.S. Patent Application Publication No. 2015/015879 (hereinafter referred to as Literature 1) discloses an image pickup apparatus that picks up images of an object using light propagating through an optical fiber made up of a multimode fiber. The image pickup apparatus is configured to obtain desired emergent light from an emergence plane of the optical fiber by making light having a wavefront corresponding to transmission characteristics of the optical fiber incident upon an incidence plane of the optical fiber. According to an invention disclosed in Literature 1, light desired to be outputted as emergent light is made incident upon an incident end face. Then, using a light wavefront formed on an emission end, the invention accurately finds a wavefront of light (hereinafter referred to as an incident wavefront) incident upon the incident end face and that is needed in order to cause desired light to be emitted from an emission end face.

### SUMMARY OF THE INVENTION

According to one aspect of the present invention, there is provided an optical scanning apparatus including: a light source; an optical fiber provided with a first end face and a second end face and configured to propagate light between the first end face and the second end face; a wavefront modulator configured to perform spatial light phase modulation of light from the light source and emit light, a reference wavefront of which is corrected based on information about the reference wavefront and correction information for use to correct the reference wavefront and make the light incident upon the first end face via a predetermined optical system, the information about the reference wavefront being generated based on information about a reference incident wavefront to be made incident upon the first end face in order to cause desired light to be emitted from the second end face; and a processor configured to control the wavefront modulator based on the correction information and the information about the reference wavefront, the correction information being found based on a correlation between a first distribution and a second distribution, the first distribution being at least one of an intensity distribution or a phase distribution of emergent light from the second end face, the second distribution being at least one of an intensity distribution or a phase distribution of the desired light.

According to another aspect of the present invention, there is provided an optical scanning apparatus including: a light source; an optical fiber provided with a first end face and a second end face and configured to propagate light between the first end face and the second end face; a wavefront modulator configured to perform spatial light phase modulation of light from the light source and emit light, a reference wavefront of which is corrected, based on information about the reference wavefront and correction information for use to correct the reference wavefront and make the light incident upon the first end face via a predetermined optical system, the information about the reference wavefront being generated based on information about a reference incident wavefront to be made incident upon the first end face in order to cause desired light to be emitted from the second end face; and a processor configured to give information about a predetermined wavefront to the wavefront modulator, and make the wavefront modulator emit light and control the wavefront modulator based on the correction information and the information about the reference wavefront by finding the information about a wavefront of emergent light from the wavefront modulator by calculation based on a first distribution and on information about a predetermined optical system and calculating the correction information based on the found information about the wavefront and information about a predetermined wavefront emitted from the wavefront modulator, the first distribution being at least one of an intensity distribution or a phase distribution of emergent light from the second end face, the intensity distribution and the phase distribution of emergent light being based on a fiber transfer function of the optical fiber and the emergent light from the wavefront modulator.

Also, according to another aspect of the present invention, there is provided an image pickup apparatus including: the optical scanning apparatus and a photodiode configured to receive reflected light from an object illuminated by illuminating light from the second end face and convert the reflected light into an electrical signal.

Also, according to another aspect of the present invention, there is provided an adjustment apparatus for an optical scanning apparatus that includes a light source, an optical fiber provided with a first end face and a second end face and configured to propagate light between the first end face and the second end face, and a wavefront modulator configured to perform spatial light phase modulation of light from the light source, emit the light, and make the light incident upon the first end face via a predetermined optical system, the adjustment apparatus including a processor configured to sequentially give correction information for use to correct a reference wavefront to the wavefront modulator of the optical scanning apparatus by changing the correction information for use to correct the reference wavefront, the correction information being generated based on information about a reference incident wavefront to be made incident upon the first end face in order to cause desired light to be emitted from the second end face; determine correction information for use to correct the reference wavefront based on a correlation between a first distribution and a second distribution, the first distribution being at least one of an intensity distribution or a phase distribution of emergent light from the second end face, the second distribution being at least one of an intensity distribution or a phase distribution of the desired light; and control the wavefront modulator based on the determined correction information and information about the reference wavefront.

Also, according to another aspect of the present invention, there is provided a method for adjusting an optical scanning apparatus that includes a light source, an optical fiber provided with a first end face and a second end face and configured to propagate light between the first end face and the second end face, and a wavefront modulator configured to perform spatial light phase modulation of light from the light source, emit the light, and make the light incident upon the first end face via a predetermined optical system, the adjustment method including sequentially giving correction information for use to correct a reference wavefront to the wavefront modulator of the optical scanning apparatus by changing the correction information for use to correct the reference wavefront, the correction information being generated based on information about a reference incident wavefront to be made incident upon the first end face in order to cause desired light to be emitted from the second end face; finding a correlation value between a first distribution and a second distribution, the first distribution being at least one of an intensity distribution or a phase distribution of emergent light from the second end face, the second distribution being at least one of an intensity distribution or a phase distribution of the desired light; determining correction information for use to correct the reference wavefront, based on a comparison result of the correction values; and controlling the wavefront modulator based on the determined correction information and information about the reference wavefront.

### BRIEF DESCRIPTION OF THE DRAWINGS

FIG. 1 is a diagram for explaining an overall configuration of an image pickup apparatus that uses an optical scanning apparatus according to a first embodiment;

FIG. 2 is a flowchart explaining an exemplary flow of a correction process for correcting light incident upon an optical fiber;

FIG. 3 is a flowchart explaining an exemplary flow of a correction process for correcting light incident upon an optical fiber; and

FIG. 4 is a diagram for explaining an overall configuration of an image pickup apparatus that uses an optical scanning apparatus according to a second embodiment.

### DETAILED DESCRIPTION OF THE PREFERRED EMBODIMENTS

Embodiments of the present invention will be described in detail below with reference to the drawings.

### First Embodiment

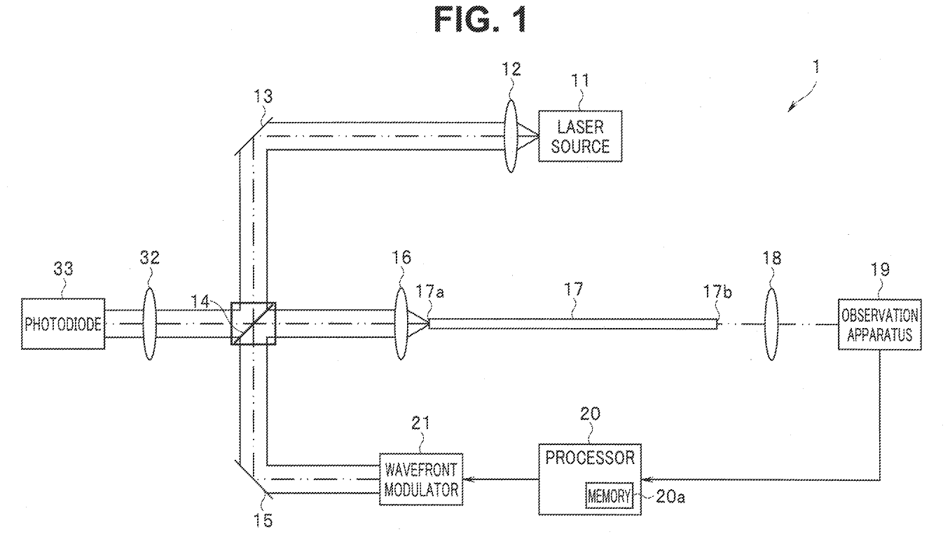

FIG. 1 is a diagram for explaining an overall configuration of an image pickup apparatus that uses an optical scanning apparatus according to a first embodiment.

The image pickup apparatus according to the present embodiment adopts an optical fiber, and a wavefront modulator made up of a spatial light phase modulator. Note that the optical fiber adopted may be a multimode fiber having multiple propagation modes (light paths) or a multicore fiber, including multiple cores, each core having one or a few transmission modes (a single mode or a few modes).

An incident wavefront needed in order to emit light of desired intensity distribution (hereinafter referred to as desired light) from an emission end face of an optical fiber will be referred to as a reference incident wavefront. The wavefront modulator is capable of generating light having a wavefront (hereinafter referred to as a reference wavefront) used to make the reference incident wavefront incident upon an incident wavefront of the optical fiber. Note that when the emission end face of the wavefront modulator and the incident end face of the optical fiber are conjugate with each other, the reference incident wavefront and the reference wavefront are identical.

The present embodiment obtains desired light from the emission end of the optical fiber by properly correcting at least one of a tilt component (incidence angle), a shift component (incident position), a spherical component (z-direction shift), or a rotational component (rotation angle) of the reference wavefront such that light having the reference incident wavefront will be incident upon the incident end face of the optical fiber regardless of mechanical installation errors and the like, as described later.

Note that although description is given below of an example in which light having the reference incident wavefront is made incident upon the incident end face of the optical fiber by changing the wavefront of light from the reference wavefront, where the light is outputted from the wavefront modulator, it is apparent that light having the reference incident wavefront may be made incident upon the incident end face of the optical fiber by causing light having the reference wavefront to be emitted from the wavefront modulator and by changing the wavefront of the reference wavefront using an optical system ranging from the emission end of the wavefront modulator to the incident end face of the optical fiber.

As shown in FIG. 1, the image pickup apparatus 1 that uses the optical scanning apparatus includes a laser source 11, a collimating lens 12, a mirror 13, a beam splitter 14, a mirror 15, a condenser lens 16, an optical fiber 17, a condenser lens 18, an observation apparatus 19, a processor 20, a wavefront modulator 21, a condenser lens 32, and a photodiode 33.

The laser source 11 is a light source that emits light of a predetermined wavelength. The collimating lens 12 collimates light emitted from the laser source 11 and emits the collimated light. The mirror 13 reflects the light collimated by the collimating lens 12 in a predetermined direction.

The beam splitter 14 and the mirror 15 are disposed on an optical path of reflected light from the mirror 13 and the beam splitter 14 emits the light from the mirror 13 to the mirror 15 by transmitting the light. The mirror 15 reflects the light transmitted through the beam splitter 14, in a predetermined direction. The wavefront modulator 21 is disposed on an optical path of reflected light from the mirror 15.

The wavefront modulator 21 is made up of a spatial light phase modulator such as a reflective liquid-crystal array (LCOS) in which multiple pixels are arranged two-dimensionally. Note that the wavefront modulator 21 is configured to change retardation within a phase retardation range of 0 to 2π in a desired tone for each pixel in the array under the control of the processor 20. A plane wave, the wavefront of which is parallel to the incident and emission end faces of the wavefront modulator 21, is made incident upon the incident and emission end faces from the mirror 15. In the wavefront modulator 21, orientation of liquid crystals making up individual pixels are controlled by the processor 20, and thus retardation of light reflected by each pixel is controlled. This allows the wavefront modulator 21 to emit light, the wavefront of which is controlled by the processor 20, toward the mirror 15.

In the present embodiment, the processor 20 is provided with a memory 20a, which stores information used by the wavefront modulator 21 in generating light having the reference wavefront. Note that the information about the reference wavefront may be acquired, for example, using a technique disclosed in Literature 1. In other words, by making desired emergent light incident upon an incident end face 17a of the optical fiber 17 and measuring the wavefront of the emergent light, the reference wavefront is found based on a wavefront phase-conjugate with the measured wavefront. Alternatively, a transfer function of the optical fiber 17 may be found and the information about the reference wavefront may be acquired from the found transfer function by calculation.

Emergent light of the wavefront modulator 21 is reflected in a direction of the beam splitter 14 by the mirror 15. The beam splitter 14 reflects the light from the mirror 15 in a predetermined direction. The condenser lens 16 is provided on an optical path of reflected light from the beam splitter 14 and configured to focus entering light and emit the light to the incident end face 17a of the optical fiber 17.

Note that although in the example described in FIG. 1, the wavefront modulator 21 is made up of a reflective liquid-crystal array, depending on a configuration of the optical system, the wavefront modulator 21 may be made up of a transmissive liquid-crystal array or the like.

The optical fiber 17 is made up, for example, of a multimode fiber and has the incident end face 17a, which is a first end face, and an emission end face 17b, which is a second end face. The optical fiber 17 propagates light incident upon the incident end face 17a using multiple propagation modes and emits the light from the emission end face 17b.

In the present embodiment, the observation apparatus 19 is disposed via the condenser lens 18 on a side of the emission end face 17b of the optical fiber 17. The condenser lens 18 is configured to focus light emitted from the emission end face 17b of the optical fiber 17 on an incident end of the observation apparatus 19.

The observation apparatus 19 is made up, for example, of a camera and configured to pick up an image of the light from the emission end face 17b of the optical fiber 17 and output the picked-up image to the processor 20. The picked-up image acquired by the observation apparatus 19 contains an intensity distribution of light appearing on the emission end face 17b of the optical fiber 17, that is, information about a phase distribution of the light appearing on the emission end face 17b. Note that apparatuses configured to directly measure the phase distribution include a Shack-Hartmann sensor.

The processor 20 may be made up of a CPU or the like and configured to operate based on programs stored in the memory 20a, thereby controlling various parts, or some or all functions may be implemented by an electronic hardware circuit such as an FPGA.

The memory 20a stores an intensity distribution of desired light to be emitted from the emission end face 17b of the optical fiber 17, that is, information about a phase distribution of the desired light. Note that reference-wavefront information stored in the memory 20a is information found about the single optical fiber 17 instead of information found about the optical fiber 17 incorporated in the image pickup apparatus 1 of FIG. 1, and depending on mechanical assembly accuracy and the like of the image pickup apparatus 1, even if light having a reference wavefront is emitted from the wavefront modulator 21 based on the reference-wavefront information stored in the memory 20a, light having a reference incident wavefront does not necessarily become incident upon the incident end face 17a of the optical fiber 17. Therefore, even if light having a reference wavefront is emitted from the wavefront modulator 21, information about the phase distribution of the light appearing on the emission end face 17b does not necessarily match the information about the phase distribution of the desired light stored in the memory 20a.

In the present embodiment, the processor 20 is configured to generate correction information for use to correct the reference wavefront, such that the phase distribution of the light appearing on the emission end face 17b will be identical with or similar to the phase distribution of the desired light stored in the memory 20a. For example, the processor 20 generates a correction value (correction information) for use to correct at least one component (hereinafter referred to as a correction component) out of a component (shift component) that shifts the reference wavefront in a predetermined direction within a plane perpendicular to an optical axis of the emergent light of the wavefront modulator 21, a component (tilt component) that tilts the reference wavefront with respect to the optical axis of the emergent light of the wavefront modulator 21, a component (rotational component) that rotates the reference wavefront around the optical axis of the emergent light of the wavefront modulator 21, and component (spherical component) that changes the reference wavefront into a spherical surface around the optical axis of the emergent light of the wavefront modulator 21.

For example, as a method for expressing the wavefront of light using a mathematical expression, a Fringe Zernike polynomial can be adopted. In the polynomial, terms and types of aberration correspond to each other, and the second and third terms of the polynomial correspond to the tilt component and the fourth term correspond to the spherical component. By adding multiple terms, a combined amount of correction can be obtained. Note that the shift component and the rotational component, wavefront shapes of which do not change, do not have corresponding terms in the polynomial. Individual correction components are independent of one another and can be controlled independently.

For example, using correction information for use to correct a predetermined correction component, the processor 20 controls the wavefront modulator 21 such that light having a wavefront resulting from correcting the reference wavefront for the correction component is emitted from the wavefront modulator 21. If the shift component is adopted as a correction component by the processor 20, when light having the reference wavefront is incident upon the incident end face 17a of the optical fiber 17, the incident position of the light on the incident end face 17a changes with the shift direction and shift amount. Also, if the tilt component is adopted as a correction component by the processor 20, when light having the reference wavefront is incident upon the incident end face 17a of the optical fiber 17, an incidence angle of the light changes with the tilt direction and tilt angle. Also, if the rotational component is adopted as a correction component by the processor 20, the reference wavefront incident upon the incident end face 17a of the optical fiber 17 rotates around a predetermined position of the incident end face 17a by a corrected angle. Also, if the spherical component is adopted as a correction component by the processor 20, the reference wavefront is incident upon the incident end face 17a of the optical fiber 17 by shifting in a direction (z direction) orthogonal to the incident end face 17a, following a curvature of a spherical surface.

Note that if a plane parallel to the incident end face 17a of the optical fiber 17 is designated as an xy plane and a direction orthogonal to the xy plane is designated as a z direction, of the correction components, the shift component and the tilt component change the reference wavefront on the xy plane, the spherical component changes the reference wavefront in the z direction, and the rotational component rotates the reference wavefront around a z axis.

As a result of the reference wavefront being corrected by the processor 20, when the light having a reference incident wavefront is incident upon the incident end face 17a, desired light is emitted from the emission end face 17b of the optical fiber 17. The processor 20 adjusts correction values of the respective correction components appropriately and thereby brings light obtained by the observation apparatus 19 as close as possible to the desired light. For example, by adjusting the correction values of the respective correction components, the processor 20 compares the phase distribution and/or intensity distribution on the wavefront of the light obtained by the observation apparatus 19 with the phase distribution and/or intensity distribution on the wavefront of the desired light, finds correction values that maximize correlation (similarity) between the obtained light and the desired light, and stores the correction values as correction information in the memory 20a.

The image pickup apparatus 1 of FIG. 1 forms, for example, spot-shaped light (light spot) as desired light and causes the light spot to be scanned (point-scanned). Then, the image pickup apparatus 1 illuminates the object by the point scanning and captures obtained object optical images in sequence and thereby obtains an image of an entire screen.

Therefore, to implement point scanning, the wavefront modulator 21 needs to generate reference wavefronts corresponding to light spots at respective scan positions. Even in this case, according to the present embodiment, at least one of the above-mentioned correction components, that is, the tilt component, the shift component, the spherical component, or the rotational component of the reference wavefront, is added to each reference wavefront. In other words, by commonly using correction information found for one reference wavefront, reference wavefronts corresponding to all the scan positions may be corrected. Consequently, a reference incident wavefront needed to obtain light spots corresponding to the individual scan positions can be made incident upon the incident end face 17a reliably. In other words, the present embodiment makes it possible to reliably implement point scanning using an extremely small amount of calculation.

In actual use, emergent light from the emission end face 17b of the optical fiber 17 is emitted to the object and reflected light from the object is incident upon the optical fiber 17 from the emission end face 17b, propagated, and emitted from the incident end face 17a. The light from the optical fiber 17 is led to the beam splitter 14 via the condenser lens 16. The beam splitter 14 transmits the light incident from the optical fiber 17 via the condenser lens 16 and leads the light to the photodiode 33 via the condenser lens 32. The photodiode 33 is configured to detect incident light by photoelectric conversion and generate an image signal based on an optical image produced by the incident light. Note that the photodiode 33 may be either a single-pixel photodiode or a two-dimensional image sensor.

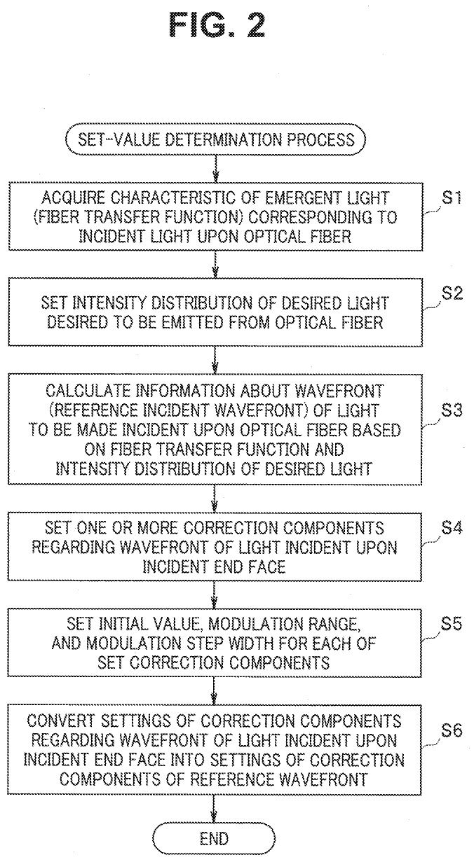

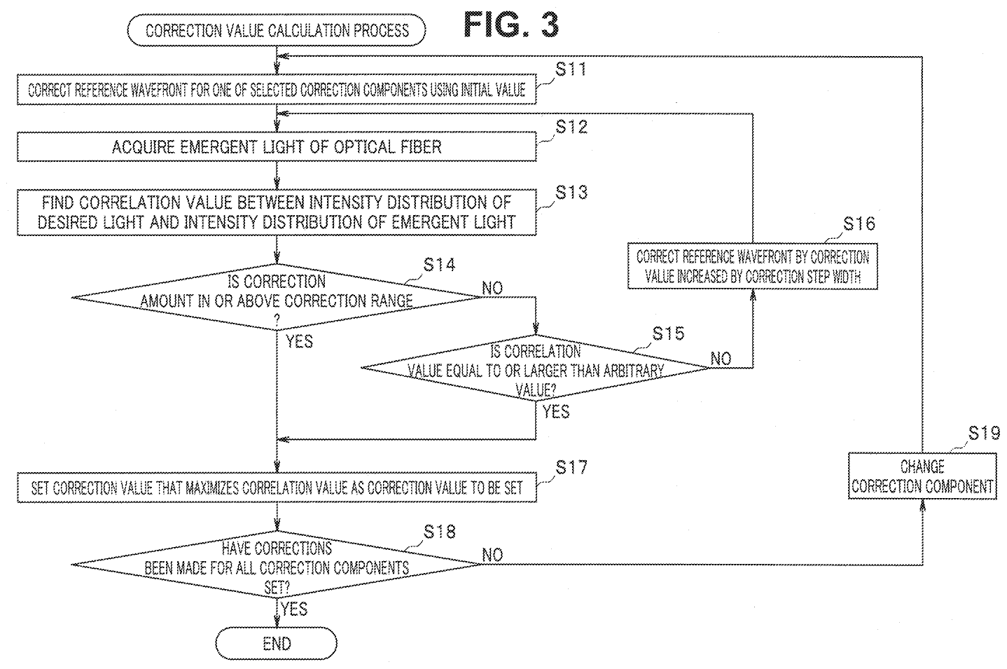

Next, operation of the embodiment configured in this way will be described with reference to FIGS. 2 and 3. FIG. 2 is a flowchart for explaining a set-value determination process and FIG. 3 is a flowchart for explaining a correction value calculation process.

The set-value determination process of FIG. 2 is preparation work for determining set values for correction value calculation of FIG. 3. First, information about desired light and information about reference wavefronts based on a reference incident wavefront are stored in the memory 20a. Steps S1 to S3 of FIG. 2 show an example of finding the reference incident wavefront. Note that the reference incident wavefront may be found using a technique disclosed in Literature 1 instead of the methods of steps S1 to S3 in FIG. 2.

In step S1 of FIG. 2, a characteristic of emergent light corresponding to a characteristic of incident light of the optical fiber 17, that is, a fiber transfer function, is acquired. In step S2, the intensity distribution of desired light desired to be emitted from the emission end face 17b of the optical fiber 17 is set. In the case of image pickup by point scanning, the desired light is a light spot. In step S3, based on the acquired fiber transfer function and information about the set intensity distribution of the desired light, information about the wavefront of light to be made incident upon the incident end face 17a of the optical fiber 17, that is, information about the reference incident wavefront is calculated. Based on the information about the reference incident wavefront and information about the optical system of the image pickup apparatus 1, information about the reference wavefront is generated and stored in the memory 20a.

In step S4, regarding the wavefront of light incident upon the incident end face 17a, at least one correction component is set out of incidence angle, incident position, z-direction shift, and rotation angle. Next, in step S5, an initial value, a correction range, and a correction step width are set for each of the set correction components.

If ϕ denotes a core diameter of the optical fiber 17, for example, the correction step width of the incident position is ϕ/10 or less in an in-plane direction of the incident end face 17a. Also, the correction step width of the z-direction shift is or less. The correction step width of the incidence angle is 5 degrees or less. The correction step width of the rotation angle is 5 degrees or less in rotation angle.

Next, in step S6, the settings of the correction components regarding the wavefront of light incident upon the incident end face 17a are converted into settings of the correction components of the reference wavefront based on information about the optical system ranging from the incident end face 17a to an emission end face of the wavefront modulator 21. As a result of step S6, the initial value, the correction range, and the correction step width are set for each of the correction components selected from the tilt component, the shift component, the spherical component, and the rotational component of the reference wavefront. Note that information about these set values is also stored in the memory 20a.

Once the information about the reference wavefront and information about the corrections of the reference wavefront are stored in the memory 20a in step S6, the processor 20 performs the correction value calculation process of FIG. 3 to find correction information (correction values). In step S11, by controlling the wavefront modulator 21 regarding one of the set correction components based on the information about the reference wavefront and an initial value of the correction information, the processor 20 corrects the reference wavefront for one of the selected correction components using the initial value.

Light from the laser source 11 is incident upon the wavefront modulator 21 via the collimating lens 12, the mirror 13, the beam splitter 14, and the mirror 15. Under the control of the processor 20, the wavefront modulator 21 emits light, the reference wavefront of which has been corrected using the initial values of the selected correction components. The light is incident upon the incident end face 17a of the optical fiber 17 via the mirror 15, the beam splitter 14, and the condenser lens 16. In this way, light, the reference wavefront of which has been corrected only for the initial values of the selected correction components on the incident end face 17a is incident upon the incident end face 17a.

The optical fiber 17 leads the light incident upon the incident end face 17a to the emission end face 17b and emits light corresponding to the corrected reference wavefront from the emission end face 17b. The observation apparatus 19 acquires light from the emission end face 17b via the condenser lens 18 and outputs information about the intensity distribution of the light emitted from the emission end face 17b, to the processor 20 (step S12).

In step S13 based on information about at least one of the phase distribution or intensity distribution of the desired light stored in the memory 20a and on information about at least one of the phase distribution or intensity distribution of the emergent light provided by the observation apparatus 19, the processor 20 finds correlation between the phase distributions, correlation between the intensity distributions, and correlation (similarity) between complex amplitude distributions including the phase distributions and the intensity distributions. The processor 20 stores the found correlation value (similarity) together with information about a correction amount in the memory 20a. Next, the processor 20 determines whether a current correction amount is in or above the correction range (step S14). In this case, since the initial value is adopted, the processor 20 goes from step S14 to step S15 and determines whether the found correlation value is equal to or larger than a predetermined threshold. If the correlation value is not equal to or larger than the predetermined threshold, the processor 20 goes to step S16, changes the correction value by the correction step width, corrects the reference wavefront for the selected correction component, and returns to step S12.

In this way, the reference wavefront from the wavefront modulator 21 is further corrected and light corresponding to the corrected reference wavefront is incident upon the incident end face 17a of the optical fiber 17. The observation apparatus 19 acquires light from the emission end face 17b via the condenser lens 18 and outputs information about the intensity distribution of the light emitted from the emission end face 17b, to the processor 20 (step S12). The processor 20 finds correlation between the intensity distribution of the desired light and the intensity distribution of the emergent light (step S13), and if the correction amount is not in or above the correction range, the processor 20 determines in step S15 whether the found correlation value is equal to or larger than a predetermined threshold.

Similar operation is repeated subsequently. If it is detected in step S14 that the correction amount has reached or exceeded the correction range or if it is detected in step S15 that the correlation value has become equal to or larger than the predetermined threshold, the processor 20 moves to step S17. If the correction amount has reached or exceeded the correction range, the processor 20 selects the correction value that provides the largest of the correlation values stored in the memory 20a and stores the selected correction value in the memory 20a as a correction value to be set (step S17). Also, if the found correlation value has become equal to or larger than the predetermined threshold, the processor 20 determines that the correlation value indicates sufficient similarity and stores the correction value that provides the correlation value in the memory 20a as a correction value to be set (step S17).

In step S18 next, the processor 20 determines whether corrections have been made for all the correction components set in step S4. If corrections have not been made for all the correction components, the processor 20 goes to step S19 and changes the correction component. Then, the processor 20 repeats the processes of steps S11 to S18. When corrections for all the correction components are finished, the processor 20 finishes processing.

In this way, correction values that maximize the correlation value between the intensity distribution of the desired wave and the intensity distribution of the emergent light from the optical fiber 17 or make the correlation value larger than the predetermined threshold are stored in the memory 20a as correction values to be set. A fundamental wavefront corrected using the correction values stored in the memory 20a causes light having a wavefront identical with or similar to the reference incident wavefront to be incident upon the incident end face 17a of the optical fiber 17 and causes light having intensity distribution identical with or similar to the desired wave to be emitted from the emission end face 17b.

In actual use of the image pickup apparatus 1, light is emitted to the object from the incident end face 17a of the optical fiber 17 without using the observation apparatus 19. Using correction values read out of the memory 20a, the processor 20 corrects the reference wavefront for at least one of the correction components, that is, the tilt component, the shift component, the spherical component, or the rotational component of the reference wavefront, and causes light having the corrected reference wavefront to be emitted from the wavefront modulator 21. Consequently, light identical with or similar to the desired light is emitted from the emission end face 17b of the optical fiber 17, making it possible to illuminate the object with light identical with or similar to the desired light.

For example, if the reference wavefront causes a light spot to be emitted from the emission end face 17b of the optical fiber 17, by controlling the wavefront modulator 21 so as to correct the reference wavefronts corresponding to multiple scan positions using the correction values stored in the memory 20a, the processor 20 can point-scan the object reliably.

Reflected light from the object illuminated by point scanning is incident upon the optical fiber 17 from the emission end face 17b, and then upon the photodiode 33 via the condenser lens 16, the beam splitter 14, and the condenser lens 32 from the incident end face 17a. This provides a picked-up image on the photodiode 33 based on object optical images produced by point scanning.

Thus, according to the present embodiment, reference wavefronts are corrected for at least one of the correction components, that is, the tilt component, the shift component, the spherical component, or the rotational component of the reference wavefront corresponding to desired light, by finding correction values based on correlation results between the intensity distribution of emergent light and the intensity distribution of desired light. Consequently, regardless of mechanical installation accuracy and the like of the optical system, by making the reference incident wavefront for use to obtain the desired light incident upon the incident end face of the optical fiber, desired light can be emitted reliably. By performing point scanning by emitting, for example, a light spot as desired light, a picked-up image of high quality can be obtained. Also, even in the case of point scanning, it is sufficient to obtain correction values for a single light spot and an amount of calculation needed for correction is relatively small.

### Second Embodiment

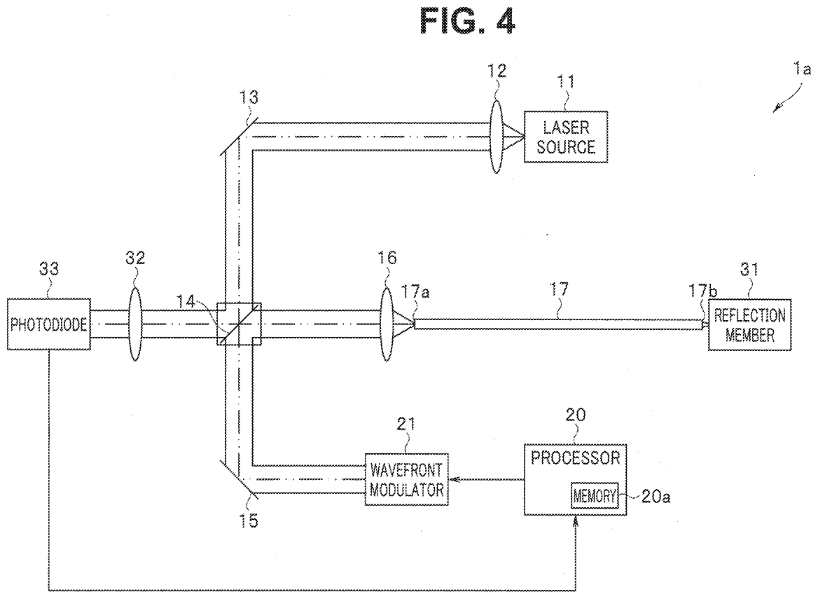

FIG. 4 is a diagram for explaining an overall configuration of an image pickup apparatus that uses an optical scanning apparatus according to a second embodiment. Note that in FIG. 4, components similar to components in FIG. 1 are denoted by the same reference numerals as the corresponding components in FIG. 1, and description of the components will be omitted.

Whereas in the first embodiment, description has been given of an example in which the intensity distribution of emergent light is acquired by the observation apparatus 19 placed on the side of the emission end face 17b of the optical fiber 17 and correction values are found based on the correlation between the intensity distribution obtained by the observation apparatus 19 and the intensity distribution of desired light, it is also possible to find the correlation between the intensity distribution of emergent light and the intensity distribution of desired light by causing emergent light from the emission end face 17b to be reflected and repropagated to the optical fiber 17 and using a light-sensing element such as the photodiode 33 placed on the side of the incident end face 17a of the optical fiber 17.

As shown in FIG. 4, in an image pickup apparatus 1a, a reflection member 31 configured to reflect light propagating through the optical fiber 17 is placed on the side of the emission end face 17b of the optical fiber 17. A mask (hereinafter referred to as a reflection mask) has been formed on the reflection member 31 such that a pattern that matches an intensity distribution pattern of desired light and increases in reflectivity with increases in the intensity is formed. For example, if the desired light is a light spot, such a reflection mask is formed on the reflection member 31 as to have a reflectivity of 1 in a spot area of the reflection member 31 to which the light spot is emitted and a reflectivity of 0 in the remaining area.

Therefore, when a light spot, which is desired light, is produced at a desired position from the emission end face 17b of the optical fiber 17, all the light incident upon the reflection member 31 is reflected. In other words, in this case, light incident upon the photodiode 33 is at a peak level. On the other hand, when a light spot, which is desired light, is not emitted from the emission end face 17b of the optical fiber 17, the light reflecting off the reflection member 31 is at a low level and the light incident upon the photodiode 33 is at a level lower than the peak level.

In other words, according to the present embodiment, the correlation (similarity) between the intensity distribution of emergent light on the emission end face 17b and the intensity distribution of desired light can be found by the photodiode 33 that detects only the intensity of light and the reflection member 31 on which the reflection mask has been formed. The photodiode 33 provides an output corresponding to the level of incident light, that is, an output at a level corresponding to the correlation (similarity) between the intensity distribution of desired light and the intensity distribution of emergent light, to the processor 20.

As with the first embodiment, the processor 20 receives output from the photodiode 33 by changing the correction value of each correction component and determines the correction value at the time when an output level of the photodiode 33 is equal to or higher than a predetermined value or reaches a maximum, as a correction value for use to obtain the desired light.

Note that although it has been stated that the reflection member 31 includes a reflection mask configured to form a pattern that matches the intensity distribution pattern of desired light and increases in reflectivity with increases in the intensity, a reflection mask having a pattern that matches the intensity distribution pattern of desired light and decreases in reflectivity with increases in the intensity may be formed as the reflection member 31. For example, if the desired light is a light spot, such a reflection mask is formed on the reflection member 31 as to have a reflectivity of 0 in a spot area of the reflection member 31 to which the light spot is emitted and a reflectivity of 1 in the remaining part. Therefore, when a light spot, which is desired light, is produced at a desired position from the emission end face 17b of the optical fiber 17, the reflection member 31 does not reflect the light. Thus, no reflected light is incident upon the photodiode 33.

On the other hand, when a light spot, which is desired light, is not emitted from the emission end face 17b of the optical fiber 17, light is reflected off the area in which the reflectivity of the reflection member 31 is 1. In this way, reflected light at a level corresponding to the intensity distribution of the incident light is detected by the photodiode 33. In this case, again, the correlation between the intensity distribution of emergent light on the emission end face 17b and the intensity distribution of desired light can be found by the photodiode 33 that detects only the intensity of light and the reflection member 31 on which the reflection mask has been formed.

The rest of the configuration and operation is similar to the first embodiment.

Although description has been given above of an example in which the reflection member 31 configured to reflect light propagating through the optical fiber 17 is placed on the side of the emission end face 17b of the optical fiber 17, this is not restrictive. For example, a reflective coating configured to control transmittance and reflectivity of the light propagating through the optical fiber 17 may be applied to the emission end face 17b of the optical fiber 17. In other words, a dielectric film may be formed on the emission end face 17b of the optical fiber 17 using a dielectric coating according to an intensity pattern of desired light.

Dielectric coating is a technique for controlling transmittance, reflectivity, and the like by interference of light. Examples of dielectric materials available for use include titanium dioxide (TiO2), ditantalum pentoxide (Ta2O5), aluminum oxide (Al₂O₃), silicon dioxide (SiO2), and magnesium fluoride (MgF2), which absorb minimal light in a wavelength range used.

Thus, the present embodiment provides advantageous effects similar to the first embodiment. Also, the present embodiment is designed to acquire the intensity distribution of the emergent light of the optical fiber using the reflection member covered with a reflection mask and the photodiode, making it possible to omit the observation apparatus. Also, by applying a reflective coating instead of the reflection member, it becomes possible to calculate correction values using only a configuration needed by an image pickup apparatus.

### Third Embodiment

Next, a third embodiment of the present invention will be described. A hardware configuration of the present embodiment is similar to the hardware configuration of the first or second embodiment.

In each of the above embodiments, for at least one of the correction components, that is, the tilt component, the shift component, the spherical component, or the rotational component of the reference wavefront, optimal correction values are found by trial and error. In the present embodiment, the optimal correction values are found by calculation.

It is assumed that information about the fiber transfer function of the optical fiber 17 is stored in the memory 20a. The processor 20 reads information about a predetermined wavefront (hereinafter also referred to as a test wavefront), e.g., information about a reference wavefront, out of the memory 20a and controls the wavefront modulator 21 such that light having the reference wavefront is emitted. Note that the test wavefront emitted in this case does not have to be the fundamental wavefront. The light having the reference wavefront and coming from the wavefront modulator 21 is incident upon the incident end face 17a of the optical fiber 17 via the mirror 15, the beam splitter 14, and the condenser lens 16. In this case, the incident wavefront may be different from the reference incident wavefront corresponding to the desired light due to mechanical installation errors and the like of the optical system. The light propagating through the optical fiber 17 is emitted from the emission end face 17b. The observation apparatus 19 acquires the intensity distribution of the emergent light and outputs the intensity distribution to the processor 20.

If In denotes a phase of light on the incident wavefront, TM denotes a fiber transfer function, and OUT denotes the intensity distribution of emergent light, that is, a phase of the emergent light, then equation (1) below holds.

In×TM=OUT (1)

Based on TM information stored in the memory 20a and information of OUT acquired from the observation apparatus 19, the processor 20 can calculate the phase In of the incident wavefront from equation (1) above. Furthermore, based on information about an ideal optical system ranging from an emission end of the wavefront modulator 21 to the incident end face 17a of the optical fiber 17, the processor 20 acquires information about the wavefront of light at the emission end of the wavefront modulator 21 that obtains the phase In of the incident wavefront. The processor 20 finds a difference between information about the acquired wavefront and the emitted test wavefront. The difference is attributable to mechanical errors and the like of the optical system ranging from an emission end of the wavefront modulator 21 to the incident end face 17a of the optical fiber 17. As correction values for use to reduce the difference to zero, the processor 20 calculates correction values for at least one of the correction components, that is, the tilt component, the shift component, the spherical component, or the rotational component with respect to the reference wavefront. The processor 20 stores the calculated correction values in the memory 20a.

In actual use, using the correction values read out of the memory 20a, the processor 20 corrects the reference wavefront for at least one of the correction components, that is, the tilt component, the shift component, the spherical component, or the rotational component of the reference wavefront, and causes light having the corrected reference wavefront to be emitted from the wavefront modulator 21. Consequently, light identical with or similar to the desired light is emitted from the emission end face 17b of the optical fiber 17, making it possible to illuminate the object in a desired manner.

In the case of point scanning, the reference wavefront varies with the position of the light spot. Even in this case, at least one correction component is used out of the tilt component, the shift component, the spherical component, and the rotational component of the reference wavefront, and every reference wavefront may be corrected using the same correction values.

Note that although description has been given of an example in which information OUT about the phase distribution of the wavefront of emergent light is found by the observation apparatus 19, regarding the second embodiment, the information OUT about the phase distribution of the wavefront of emergent light may be found using the reflection member 31 and the photodiode 33.

Thus, the present embodiment provides advantageous effects similar to those of the first and second embodiments.

In the flowcharts herein, by changing the execution sequence of individual steps, multiple steps may be carried out simultaneously or steps may be carried out with the sequence varied from run to run as long as the changes are not inconsistent with the nature of the procedures.

The present invention is not limited to any of the precise embodiments described above, and may be embodied by changing components in the implementation stage without departing from the gist of the invention. Also, the invention can be implemented in various forms using appropriate combinations of the components disclosed in the above embodiments. For example, some of the components disclosed in the embodiments may be deleted. Furthermore, components may be combined as appropriate across different embodiments.

What is claimed is:

1. An optical scanning apparatus comprising:
a light source;
an optical fiber provided with a first end face and a second end face and configured to propagate light between the first end face and the second end face;
a wavefront modulator configured to perform spatial light phase modulation of light from the light source and emit light, a reference wavefront of which is corrected, based on information about the reference wavefront and correction information for use to correct the reference wavefront and make the light incident upon the first end face via a predetermined optical system, the information about the reference wavefront being generated based on information about a reference incident wavefront to be made incident upon the first end face in order to cause desired light to be emitted from the second end face; and
a processor configured to control the wavefront modulator based on the correction information and the information about the reference wavefront, the correction information being found based on a correlation between a first distribution and a second distribution, the first distribution being at least one of an intensity distribution or a phase distribution of emergent light from the second end face, the second distribution being at least one of an intensity distribution or a phase distribution of the desired light.

2. The optical scanning apparatus according to claim 1, wherein the processor is provided with information about the first distribution of the emergent light from the second end face, calculates a correlation value between the first distribution and the second distribution of the desired light, and finds the correction information.

3. The optical scanning apparatus according to claim 1, wherein the processor is provided with an output corresponding to a correlation between the first distribution and the second distribution, and finds the correction information.

4. The optical scanning apparatus according to claim 1, wherein the correction information includes information for use to correct at least one of a shift component, a tilt component, a rotational component, or a spherical component, where the shift component shifts the reference wavefront in a predetermined direction within a plane perpendicular to an optical axis of the emergent light of the wavefront modulator, the tilt component tilts the reference wavefront with respect to the optical axis of the emergent light of the wavefront modulator, the rotational component rotates the reference wavefront around the optical axis of the emergent light of the wavefront modulator, and the spherical component changes the reference wavefront into a spherical surface around the optical axis of the emergent light of the wavefront modulator.

5. The optical scanning apparatus according to claim 2, further comprising an observation apparatus provided on a side of the second end face and configured to acquire the first distribution, wherein
the processor finds the correlation value by changing the correction information and sets correction information that gives a largest correlation value or a correlation value larger than a predetermined correlation value as correction information for use to correct the reference wavefront.

6. The optical scanning apparatus according to claim 3, further comprising:
a reflection member provided on a side of the second end face and having reflectivity corresponding to the second distribution; and
a light-sensing element configured to acquire intensity of light reflected off the reflection member, made incident upon the optical fiber from the second end face, and emitted from the first end face, and produce an output corresponding to the correlation, wherein
the processor changes the correction information and sets the correction information that makes an output level of the light-sensing element highest or higher than a predetermined level as correction information for use to correct the reference wavefront.

7. The optical scanning apparatus according to claim 3, further comprising:
a reflective coating provided on the second end face and having reflectivity corresponding to the second distribution; and
a light-sensing element configured to acquire intensity of light reflected off the reflective coating, made incident upon the optical fiber from the second end face, and emitted from the first end face, and produce an output corresponding to the correlation, wherein
the processor changes the correction information and sets the correction information that makes an output level of the light-sensing element highest or higher than a predetermined level as correction information for use to correct the reference wavefront.

8. The optical scanning apparatus according to claim 1, further comprising a memory configured to store information about the reference wavefront, information about the second distribution, and the correction information.

9. The optical scanning apparatus according to claim 1, wherein the processor controls the wavefront modulator using common correction information for a plurality of reference wavefronts corresponding to a plurality of desired lights.

10. An optical scanning apparatus comprising:
a light source;
an optical fiber provided with a first end face and a second end face and configured to propagate light between the first end face and the second end face,
a wavefront modulator configured to perform spatial light phase modulation of light from the light source and emit light, a reference wavefront of which is corrected, based on information about the reference wavefront and correction information for use to correct the reference wavefront and make the light incident upon the first end face via a predetermined optical system, the information about the reference wavefront being generated based on information about a reference incident wavefront to be made incident upon the first end face in order to cause desired light to be emitted from the second end face; and
a processor configured to give information about a predetermined wavefront to the wavefront modulator, and make the wavefront modulator emit light and control the wavefront modulator based on the correction information and the information about the reference wavefront by finding the information about a wavefront of emergent light from the wavefront modulator by calculation based on a first distribution and on information about a predetermined optical system and calculating the correction information based on the found information about the wavefront and information about a predetermined wavefront emitted from the wavefront modulator, the first distribution being at least one of an intensity distribution or a phase distribution of emergent light from the second end face, the intensity distribution and the phase distribution of emergent light being based on a fiber transfer function of the optical fiber and the emergent light from the wavefront modulator.

11. The optical scanning apparatus according to claim 4, wherein if ϕ denotes a core diameter of the optical fiber, at least one of the following conditions is satisfied:
an amount of correction made on the first end face by the shift component that shifts the reference wavefront in the predetermined direction within the plane perpendicular to the optical axis of the emergent light of the wavefront modulator is ϕ/10 or less in an in-plane direction of the first end face;
an amount of correction made on the first end face by the spherical component that changes the reference wavefront into a spherical surface around the optical axis of the emergent light of the wavefront modulator is ϕ or less in a direction orthogonal to the first end face,
an amount of correction made on the first end face by the tilt component that tilts the reference wavefront with respect to the optical axis of the emergent light of the wavefront modulator is 5 degrees or less; and
an amount of correction made on the first end face by the rotational component that rotates the reference wavefront around the optical axis of the emergent light of the wavefront modulator is 5 degrees or less in terms of rotation angle around an axis orthogonal to the first end face.

12. An image pickup apparatus comprising:
an optical scanning apparatus; and
a photodiode,
wherein the optical scanning apparatus includes a light source, an optical fiber provided with a first end face and a second end face and configured to propagate light between the first end face and the second end face, a wavefront modulator configured to perform spatial light phase modulation of light from the light source and emit light, a reference wavefront of which is corrected, based on information about the reference wavefront and correction information for use to correct the reference wavefront and make the light incident upon the first end face via a predetermined optical system, the information about the reference wavefront being generated based on information about a reference incident wavefront to be made incident upon the first end face in order to cause desired light to be emitted from the second end face, and a processor configured to control the wavefront modulator based on the correction information and the information about the reference wavefront, the correction information being found based on a correlation between a first distribution and a second distribution, the first distribution being at least one of an intensity distribution or a phase distribution of emergent light from the second end face, the second distribution being at least one of an intensity distribution or a phase distribution of the desired light, and
the photodiode receives reflected light from an object illuminated by illuminating light from the second end face and converts the reflected light into an electrical signal.

13. An adjustment apparatus for an optical scanning apparatus that includes a light source, an optical fiber provided with a first end face and a second end face and configured to propagate light between the first end face and the second end face, and a wavefront modulator configured to perform spatial light phase modulation of light from the light source, emit the light, and make the light incident upon the first end face via a predetermined optical system, the adjustment apparatus comprising:
a processor configured to sequentially give correction information for use to correct a reference wavefront to the wavefront modulator of the optical scanning apparatus by changing the correction information for use to correct the reference wavefront, the correction information being generated based on information about a reference incident wavefront to be made incident upon the first end face in order to cause desired light to be emitted from the second end face, determine correction information for use to correct the reference wavefront based on a correlation between a first distribution and a second distribution, the first distribution being at least one of an intensity distribution or a phase distribution of emergent light from the second end face, the second distribution being at least one of an intensity distribution or a phase distribution of the desired light, and control the wavefront modulator based on the determined correction information and information about the reference wavefront.

14. A method for adjusting an optical scanning apparatus that includes a light source, an optical fiber provided with a first end face and a second end face and configured to propagate light between the first end face and the second end face, and a wavefront modulator configured to perform spatial light phase modulation of light from the light source, emit the light, and make the light incident upon the first end face via a predetermined optical system, the adjustment method comprising:
sequentially giving correction information for use to correct a reference wavefront to the wavefront modulator of the optical scanning apparatus by changing the correction information for use to correct the reference wavefront, the correction information being generated based on information about a reference incident wavefront to be made incident upon the first end face in order to cause desired light to be emitted from the second end face;
finding a correlation value between a first distribution and a second distribution, the first distribution being at least one of an intensity distribution or a phase distribution of emergent light from the second end face, the second distribution being at least one of an intensity distribution or a phase distribution of the desired light;
determining correction information for use to correct the reference wavefront, based on a comparison result of the correction values; and
controlling the wavefront modulator based on the determined correction information and information about the reference wavefront.
